(19) United States
(12) Patent Application Publication
(10) Pub. No.: US 2011/0174945 A1
(43) Pub. Date: Jul. 21, 2011

(54) SPORTING GOODS SUPPORT PLATE

(76) Inventor: DONALD M. WOOD, St. Louis, MO (US)

(21) Appl. No.: 12/688,283

(22) Filed: Jan. 15, 2010

(51) Int. Cl. F16M 13/00

(52) U.S. Cl. 248/225.11

(57) ABSTRACT

A sporting goods support plate has a single plate that secures to fencing prevalent at diamonds. The plate has a rounded end and a generally square end with at least one slot on the square end. The at least one slot engages an intersection of wire of chain link fence so that the square end fits into the apertures of the fence in a cantilevered arrangement. A pair of posts cooperates with the slot as the plate cantilevers outwardly from a fence. The plate has an opening there through for a beverage containers, pegs for gloves, keys, clothing, bags, and helmets, and a slot for a bat. The plate fits within equipment bags common among ball players and teams.

### BACKGROUND OF THE INVENTION

The sporting goods support plate generally relates to athletic equipment and more specifically to storage devices for baseball and softball equipment. The invention relates to sports accessories that organize and store drinks, bats, gloves, helmets, balls, and the like upon fencing prevalent at diamonds across the country.

For over a century, people of all ages have played baseball and more recently softball. Both games have two teams with one team in the field of a diamond and the other team in a dugout while individual players hit balls pitched to them at various speeds. When in the field, each player has their glove and the rest of their equipment remains in the dugout. When hitting, each player has their helmet and bat, but the rest of their equipment remains in the dugout. When not hitting, each player sits in the dugout with their equipment. Though baseball and softball have a minimum of nine players, teams often have more players for various positions and skills. A dugout becomes a crowded place with players and their equipment.

Dugouts take various forms depending on the construction of the ballpark, or diamond. Major league baseball has large ballparks that seat over 50,000 fans with dugouts constructed of concrete much like a building partially set After wagons, transportation companies developed trucks in the last century.

To a ballplayer, keeping equipment organized often has the highest difficulty from haste and inattention but with health and pocketbook consequences. Health consequences arise when other ballplayers unwittingly drink from sports bottles or beverage containers of a ballplayer thus spreading disease. Lice and other diseases can spread from other ballplayers unwittingly wearing the helmet of a ballplayer. Pocketbook consequences occur when a ballplayer's bat endures dings and other abuses from other ballplayers. A ballplayer's glove or mitt may fall into dirt or mud around a diamond and possibly endure tearing from the spikes of other ballplayers.

### DESCRIPTION OF THE PRIOR ART

In dugouts and around diamonds, players, coaches, and parents have made do with various storage methods and some devices. Most diamonds have fencing for at least a backstop behind home plate and many diamonds also have fencing along the foul lines that define the left and right boundaries of a field. The fencing is generally chain link and readily available. The chain link has a diamond shaped pattern formed by stretching and weaving wire into an open mesh.

The open mesh provides plenty of holes at accessible heights for players, coaches, and parents. Players often stick the handle of a bat into a fence opening and the handle grips an adjacent crossing of two wires at the top of an opening. The bat then hangs from the fencing usually downwardly and outwardly from the fence. This hanging method can deform the fence in time, scrape the bat handles, and extend into pathway leading to a risk of tripping players, coaches, and others who walk past.

Chain link fencing usually has twisted wire ends at its outer edges. Occasionally, the twist wire ends are bent over to reduce risk of grabbing. The twisted wire ends, unbent or bent, usually serve as a hook for gloves, clothing, straps, and handles. In time, the twisted wire end can scrape the items hung from them and the items may also further bend the twisted wire ends.

Players, parents, and coaches have also utilized various S or J shaped hooks, such as from coat hangers, to store equipment and clothing around a dugout or diamond. The hooks engage fencing or other nearby edges and then suspend items placed upon them. However, hooks can be lost or left behind after a ball game or practice session. The hooks also have limited ability to grip round or cylindrical beverage containers.

The patent to Halverson, D273,162 provides a rack or similar article having a top rack with a plurality of slots for bats. The rack has a strut, either wire or plate that extends at an angle beneath the rack downwardly and rearwardly for attachment to a fence. The present invention though does not use a strut but rather posts at one end to secure it to a fence.

The present invention overcomes the disadvantages of the prior art and provides a sporting goods support plate that eliminates bats sticking outwardly from a fence. The present invention also simultaneously stores bats, gloves, beverage containers, and clothing upon one device. The present invention also installs upon fencing readily and removes from fencing with little effort.

### SUMMARY OF THE INVENTION

Generally, the sporting goods support plate has a planar plate with a generally rectangular form. The plate has a first end, generally rectangular that engages fencing, and an opposite second end, generally rounded with a slot that receives a bat. The plate has two mutually parallel sides between the first end and the second end. The plate has at least one opening there through that admits a beverage container and at least one peg upon at least one side that receives a glove or other item for suspension beneath the plate. The slot fits over an intersection of chain link fencing while the remainder of the first end enters the chain link fencing outwardly of the intersection. The plate cantilevers outwardly from fencing and supports various baseball equipment placed thereon.

There has thus been outlined, rather broadly, the more important features of the invention in order that the detailed description thereof that follows may be better understood and that the present contribution to the art may be better appreciated. The present invention also includes at least one post from said plate upwardly that engages behind the fencing, a recess upon the slot that accepts the knob of a bat, and tapering upon the opening for acceptance of various diameter beverage containers. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a sporting goods support plate that organizes and stores baseball and softball equipment upon a fence over a minimum area.

Another object is to provide such a sporting goods support plate that has a one piece construction for simple manufacturing.

Another object is to provide such a sporting goods support plate that provides a sturdy platform that cantilevers outwardly from fencing found at diamonds across the country.

Another object is to provide such a sporting goods support plate that has a low cost of manufacturing so the purchasing players, coaches, parents, leagues, and organizations can readily buy the sporting goods support plate through stores and supply sources.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows a top view of the present invention;

FIG. 2 describes a bottom view of the invention, generally opposite that of FIG. 1;

FIG. 3 provides a perspective view of the present invention;

FIG. 4 provides a perspective view of an alternate embodiment of the present invention; and,

FIG. 5 illustrates a perspective view of the present invention deployed upon fencing.

The same reference numerals refer to the same parts throughout the various figures.

### DESCRIPTION OF THE PREFERRED EMBODIMENT

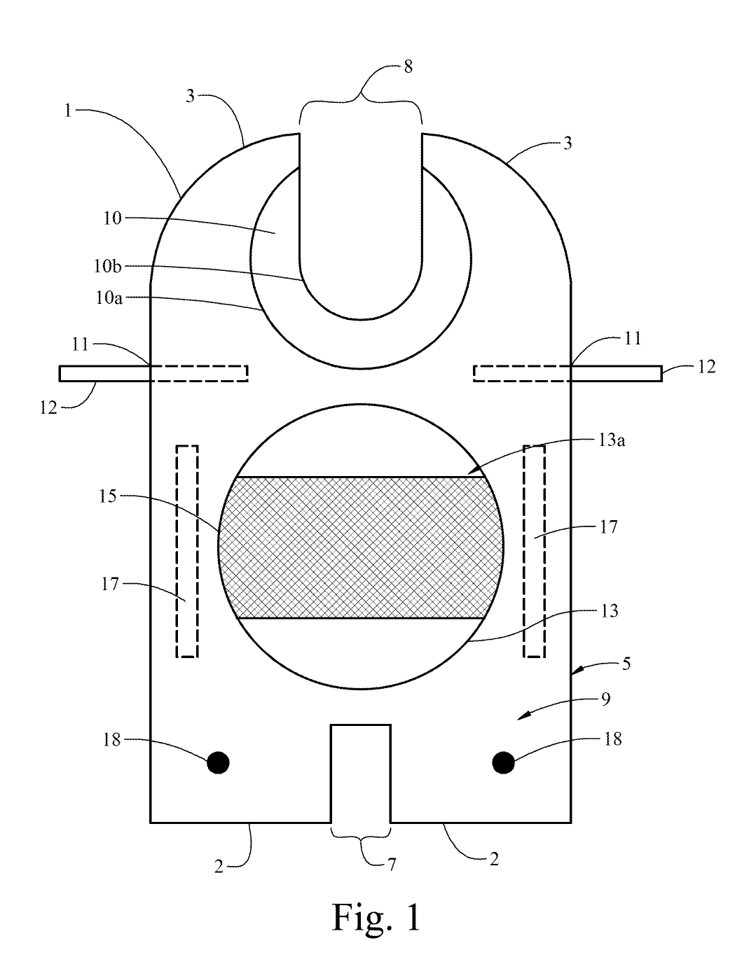

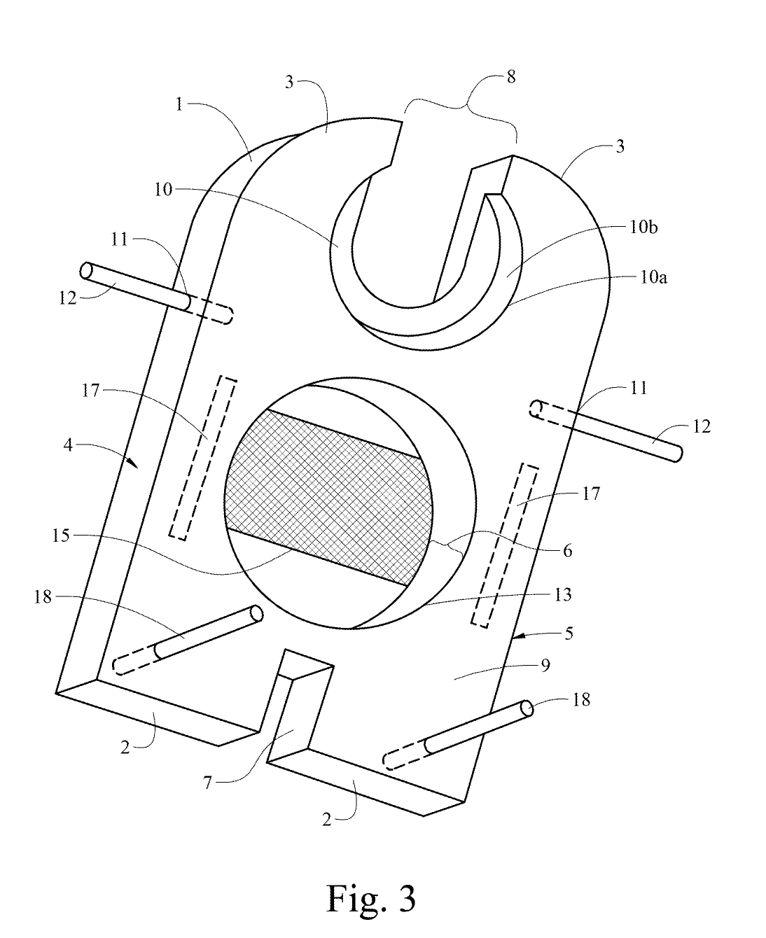

The present art overcomes the prior art limitations by providing a sporting goods support plate, or dugout butler, as in FIG. 1, that overcomes the limitations of prior devices and methods for storing batting equipment for baseball and softball players, coaches, staff, and parents. The present invention shown in FIG. 1 begins with a plate 1 having a generally planar form with a rectangular shape. The plate has a first end 2 generally square and an opposite second end 3 preferably rounded. The first end and the second end are joined by two mutually parallel and spaced apart sides, a first side 4 and an opposite second side 5. The sides generally have a right angle orientation to the first end 2 and a rounded orientation to the second end 3. The plate has a thickness 6 later shown in FIG. 3.

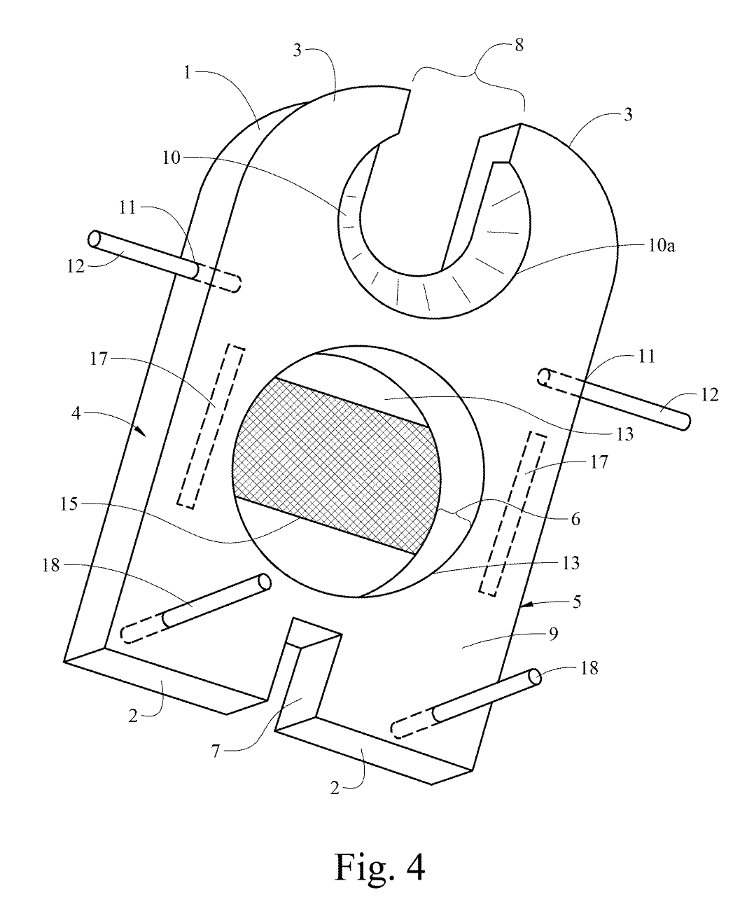

The first end and the second end span between the sides 4, 5 and are generally shorter in length than the sides. The sides extend generally parallel to a longitudinal axis of the plate while the ends are perpendicular to the longitudinal axis of the plate. The first end includes a first slot 7 extending inwardly into the plate. The first slot is generally centered upon the first end and has a width slightly more than the width of an intersection of chain link fencing, as later shown in FIG. 4. The width of the slot greater than the intersection of the fencing allows the plate to rest slightly below the intersection. The slot extends into the plate for a distance at least that of the width of an intersection and preferably for a distance at least the thickness of the plate as at 6.

Opposite the first end, the second end 3 has a second slot 8. The second slot also extends into the plate towards the first slot 7. Centered upon the second end, the second slot has a width slightly more than the narrowest diameter of a bat handle. The width of the second slot is approximately 1.3 inches. The second slot proceeds into the plate more than the width. Preferably, the second slot extends into the plate for the thickness 6 of the plate and the narrowest bat diameter.

Bounded by the first end 2, the second end 3, the first side 4, the second side 5, the first slot 7, and the second slot 8, the plate has a top surface 9. The top surface orients upwardly when the invention upon installation of the invention. The top surface is generally planar and perpendicular to the first end and the first side. The top surface extends outwardly from the first end towards the second end. Proximate the second end and particularly the second slot, the top surface has a recess 10 for an alternate embodiment of the invention. The recess is generally round in shape and centered upon the second slot. The recess has an outside diameter 10a that slightly exceeds the diameter of the knob of a bat. The recess also has a depth 10b, as shown in FIG. 3. The depth is generally half of the thickness of the plate as at 6, similar to half of the thickness of the knob of a bat. The recess has an inside diameter 10c generally that of the width of the second slot 8. In the preferred embodiment, the recess has a generally square cut into the plate where the outside diameter continues into the thickness of the plate for the depth of the recess. In an alternate embodiment, the recess has a beveled cut where the recess has its outside diameter taper from that of a knob upon a sporting equipment, such as a bat, to its inside diameter that of the width of the second slot over the depth of the recess. The recess receives the knob of a bat for storage upon the plate.

Along the first side 4 and the second side 5, the plate has two collinear apertures 11 generally along a line proximate the outside diameter of the recess. Each aperture receives a peg 12 inserted therein. The pegs extend outwardly and perpendicular to the sides 4, 5. The pegs have a length beyond the plate of at least the thickness of the plate, that is, generally long enough to receive a strap from a glove or the collar of an article of clothing. The pegs are generally elongated cylinders.

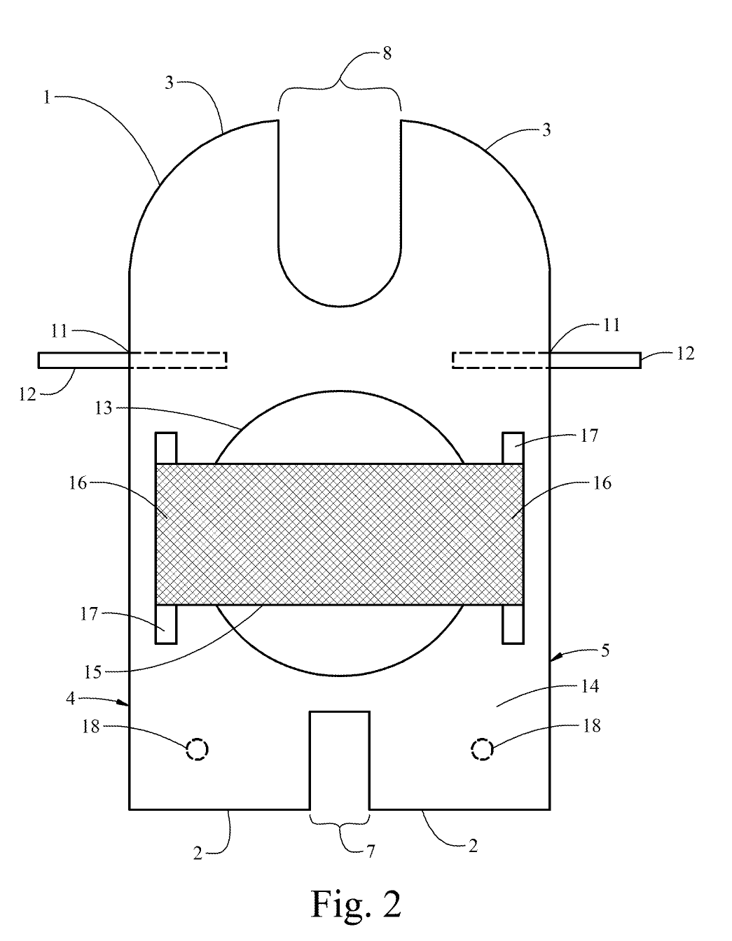

Inwardly from the second slot 8 and generally centered between the sides 4, 5, the plate has an opening 13 through its thickness as at 6. The opening is round and has a diameter 13a slightly smaller than a 12 oz. beverage can. Opposite the top surface 9, the plate has a bottom surface 14 bounded by the ends 2, 3 and the sides 4, 5. Adjacent to the bottom surface 14, the plate has a flexible retainer 15 that spans across the opening. The retainer 15 has an approximate length of three inches and a width of at least one inch. The flexible retainer prevents beverage containers of various diameters from slipping through the opening. The retainer also holds containers not of a round shape but inside the opening upon the plate. The retainer has two opposite ends 16 secured into slots 17 in the bottom surface 14 as later shown in FIG. 2.

Outwardly from the opening 13 and opposite the recess 10, the plate 1 has at least one post 18. FIG. 1 shows two posts 18 generally symmetrically spaced about the first slot 7, or alternatively centered upon the first slot. Each post extends upwardly and perpendicular to the top surface 9. The posts are generally elongated cylinders of a narrow diameter. The posts engage the wires of chain link fencing outwardly from an intersection of the same fencing as later shown in FIG. 4.

Turning the plate over, FIG. 2 shows the plate 1 from a bottom view. As above, the plate is generally rectangular with a square first end 2 with a slot 7 that engages a fence and an opposite rounded second end 3 with a second slot 8 that receives a bat. Spanning between the two ends, the plate has the spaced apart first side 4 and the second side 5, each with apertures 11 that receive pegs 12 for holding gloves and clothing. Between the second slot and the first slot, the plate has the opening 13 with its diameter that allows the plate to receive a container, usually for a beverage. The opening passes from the top surface 9 shown in FIG. 1 to the bottom surface 14 here shown in FIG. 2.

The bottom surface has two recessed third slots 17, mutually parallel and spaced apart outwardly of the opening 13. The slots 17 have a generally parallel orientation to the first side 4. Alternatively, the slots may have locations between the first and second slots. The third slots 17 have a generally narrow and elongated rectangular shape suitable for receiving and securing the ends 16 of the retainer 15. The retainer 15 extends across the opening, generally adjacent to the bottom surface, and outwardly to the third slots. The ends 16 of the retainer then insert into the third slots for securement by adhesive, wedge action, mechanical fasteners, such as brads, and the like. In the preferred embodiment, the retainer has an orientation generally parallel to the first end 2 and the pegs 12. The retainer then stands ready to receive a container, generally round, placed therein.

Removing the plate 1 of the present invention from a carrier, a user sees the invention as shown in FIG. 3. The plate 1 has its first slot 7 proximate the first end 2 with two posts 18 equally spaced on both sides of the slot. The posts have a generally round shape that extends upwardly and perpendicular to the top surface 9. Outwardly from the posts, the plate has the opening 13 with the retainer 15, often webbing, below the top surface. The retainer is generally adjacent to the bottom surface 14 as previously described. The retainer beneath shows the thickness 6 of the plate. Above the retainer, the opening has its round shape for various beverages primarily. Outwardly from the opening and proximate the second slot 8, the plate has the recess 10 generally round in shape and centered upon the second slot. The recess has its outside diameter 10a that slightly exceeds the diameter of the knob of a bat. The recess also has a depth 10b into the thickness of the plate beneath the top surface 9. The depth is generally half of the thickness of the plate as at 6, similar to half of the thickness of the knob of a bat. The recess has an inside diameter 10c generally that of the width of the second slot 8. In the preferred embodiment, the recess has a generally square cut into the plate where the outside diameter continues into the thickness of the plate for the depth of the recess. In an alternate embodiment shown in FIG. 4, the recess has a beveled cut where the recess has the outside diameter taper to the inside diameter over the depth of the recess. The recess then has an angled surface between the top surface and the depth of the recess at the second slot. The recess receives the knob of a bat for storage upon the plate.

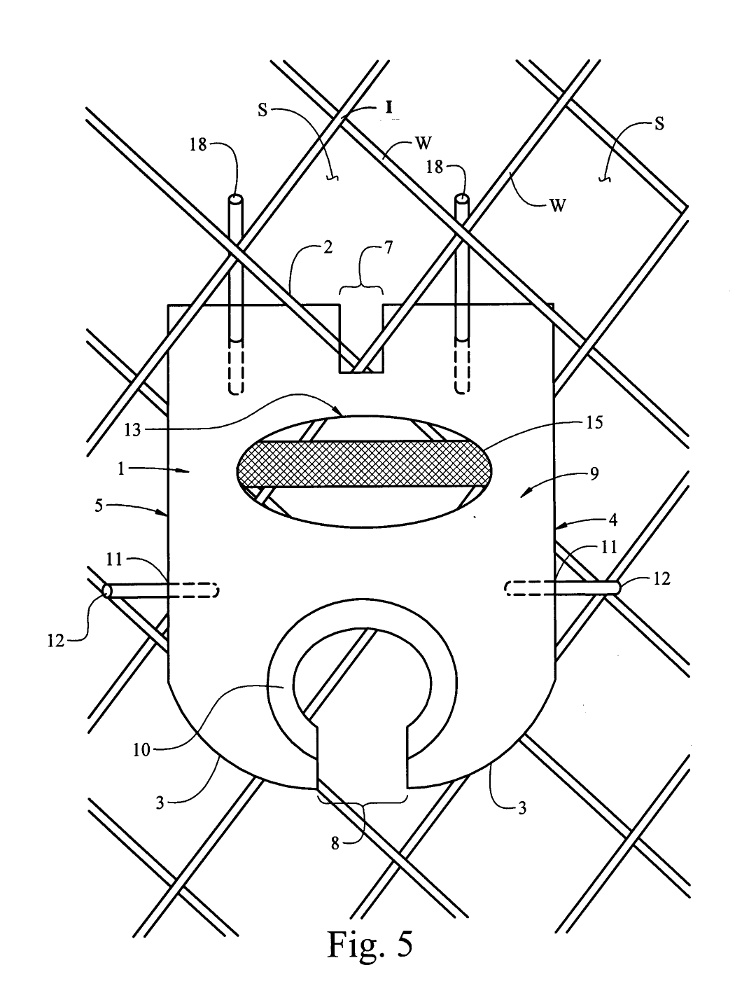

At the ball diamond, chain link fencing serves as the backstop behind home plate that generally extends towards nearby dugouts. Other ball diamonds have fencing that extends parallel to the foul lines for a distance beyond the dugouts toward the foul poles. Other ball diamonds then have fencing extending to the outfield fence. The fencing appears as in FIG. 5 where woven wires W form a diamond pattern of spaces S defined by intersections, as at I, of the two wires. The wires have a woven pattern and thus the intersections occur at a known interval as shown. The present invention utilizes the three nearby intersections arranged in a compact V shape. A user places the plate 1 near the fencing with the second end generally upwardly. The user places the two posts 18 through two adjacent spaces generally upwardly towards the top of the fence, that is opposite the brick dust or other ground of the ball diamond. The user then moves the posts behind two adjacent intersections I and gently lowers the plate towards the fence in a downward hinge like motion. The user then locates the plate so that the first end 2 abuts the fence with an intersection I entering the first slot 7. The first slot has sufficient width to admit the intersection I and a short length of the wires W generally above the plate, that is, towards the top of the fence. A user then places a bat, glove, shirt, beverage container, and the like upon the plate 1, second slot 8, and pegs 12. When loaded, the plate 1 has the first end, particularly the first slot, resting upon the wires below an intersection I and the posts 18 abutting the wires W of two intersections I above the first slot. The plate cantilevers outwardly from the fence ready for players, coaches, and parents to store various items upon the plate.

From the aforementioned description, a sporting goods support plate has been described. The sporting goods support plate is uniquely capable of securing upon chain link fencing without tools, and holding bats, gloves, and beverage containers common at ball diamonds. The sporting goods support plate has a slot that engages the fence and an opposite slot that receives a bat handle along with various pegs that support gloves and clothing among other things. The sporting goods support plate and its various components may be manufactured from many materials, including but not limited to, steel, aluminum, polymers, nylon, polyvinyl chloride, high density polyethylene, polypropylene, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device that stores sporting equipment upon chain link fencing, comprising:
a plate having a first end and an opposite second end, a first side and a spaced apart second side, said first end and said second end each spanning between said first side and said second side thus defining a generally rectangular shape of said plate, a top surface and an opposite bottom surface separated by a thickness;
said first end having a first slot extending inwardly towards said second end, wherein said first slot engages chain link fencing;
said second end having a second slot extending inwardly towards said first end, said second slot being wider than said first slot wherein said second slot receives sporting equipment; and,
at least one post extending perpendicular to said top surface and locating outwardly of said first slot, said at least one post cooperating with said first slot;
wherein said device extends generally perpendicular to the chain link fencing as a cantilever.

2. The sporting equipment storage device of claim 1 further comprising:
said top surface having a recess therein centered upon said second slot and extending into said top surface by approximately one third of said thickness, said recess having a width generally greater than said second slot and said second slot extends into said recess.

3. The sporting equipment storage device of claim 2 further comprising:
said recess being round and having a depth and a diameter approximately that of a knob upon sporting equipment and said diameter being the same for the depth of said recess wherein said recess receives the sporting equipment.

4. The sporting equipment storage device of claim 2 further comprising:
said recess being round and having a diameter at said top surface, a beveled surface extending from said top surface downwardly and inwardly to said second slot;
wherein said recess has its diameter narrowing from that of a knob upon sporting equipment to the width of said second slot; and,
wherein said recess receives the sporting equipment.

5. The sporting equipment storage device of claim 1 further comprising:
said plate having an opening through said thickness and locating inwardly from said first slot and said second slot, said opening having a diameter greater than the width of said second slot;
said bottom surface having at least one recessed slot therein outwardly from said opening, said at least one recessed slot being generally parallel to said first slot and having a length generally less than the diameter of said opening; and,
a retainer adjacent to said bottom surface having a length greater than the diameter of said opening and a width generally proximate the length of said recessed slot;
wherein said opening receives a cylindrical container.

6. The sporting equipment storage device of claim 5 wherein said bottom surface has two recessed slots being mutually parallel and spaced apart, said retainer secures to said two recess slots, and said retainer is flexible.

7. The sporting equipment storage device of claim 1 wherein said plate has two posts mutually spaced apart and spaced about said first slot.

8. The sporting equipment storage device of claim 1 further comprising:
said plate having at least one peg in one of said first side and said second side.

9. The sporting equipment storage device of claim 1 wherein said plate has a peg perpendicular to said first side and a peg perpendicular to said second side, said pegs proximate said second slot.

10. The sporting equipment storage device of claim 9 wherein said pegs are coaxial.

11. A device that stores sporting equipment and related items cantilevered upon chain link fencing, comprising:
a plate having a first end and an opposite second end, a first side and a spaced apart second side, said first end and said second end each spanning between said first side and said second side thus defining a generally rectangular shape of said plate, a top surface and an opposite bottom surface separated by a thickness;
said first end having a first slot extending inwardly towards said second end, wherein said first slot engages chain link fencing;
said second end having a second slot extending inwardly towards said first end, said second slot being wider than said first slot wherein said second slot receives sporting equipment;
two posts extending perpendicular to said top surface and locating outwardly of said first slot and spaced mutually apart, said posts cooperating with said first slot wherein said device extends generally perpendicular to the chain link fencing;
said top surface having a recess therein centered upon said second slot and extending into said top surface by approximately one third of said thickness, said recess having a width generally greater than said second slot and said second slot extends into said recess;
said plate having an opening through said thickness and locating inwardly from said first slot and said second slot, said opening having a diameter greater than the width of said second slot, wherein said opening receives a cylindrical container;
said bottom surface having two recessed slots being mutually parallel and spaced apart outwardly from said opening, and a length generally less than the diameter of said opening;
a flexible retainer adjacent to said bottom surface having a length greater than the diameter of said opening and a width generally proximate the length of said recessed slots, said retainer securing to said recessed slots;
said plate having a peg perpendicular to said first side and another peg perpendicular to said second side, said pegs being proximate said second slot and said pegs being coaxial; and,
wherein said plate is generally symmetric along an axis between said first slot and said second slot.
